(19) United States
(12) Patent Application Publication
(10) Pub. No.: US 2008/0285816 A1
(43) Pub. Date: Nov. 20, 2008

(54) Digital image processing apparatus for displaying histogram and method thereof

(75) Inventors: Jin-dong Kim, Seongnam-si (KR); Jong-hwan Lee, Seongnam-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/903,157

(22) Filed: Sep. 20, 2007

(30) Foreign Application Priority Data
May 16, 2007 (KR) 10-2007-0047829

(51) Int. Cl. G06K 9/00

(52) U.S. Cl. 382/118

(57) ABSTRACT

A digital image processing apparatus displaying a histogram. The apparatus includes a face recognition portion recognizing at least one face area in an image, a histogram generation portion generating a histogram of the face area, and a display for displaying the histogram of the face area or an indicator indicating an average value corresponding to the histogram of the face area. Accordingly, a histogram of a face area of a person, which is typically the main object of an image, is displayed. A preferred exposure value can be obtained from a user, the calculated exposure values can be corrected and the exposure of a photograph can be quantitatively seen.

### CROSS-REFERENCE TO RELATED PATENT APPLICATIONS

This application claims the benefit of Korean Patent Application No. 10-2007-0047829, filed on May 16, 2007, in the Korean Intellectual Property Office, the disclosure of which is incorporated herein in its entirety by reference.

### BACKGROUND OF THE INVENTION

1. Field of the Invention

The present invention relates to a digital image processing apparatus and a method thereof, and more particularly, to a digital image processing apparatus for displaying a histogram of the total image area and a histogram of a face area, and an operation method thereof.

2. Description of the Related Art

Digital image processing apparatuses with LCD displays provide histogram information in preview images or during image reproduction to enable a user to easily recognize a degree of exposure of a photographed image. FIG. 1 shows a histogram of a preview image or a reproduced image displayed in a digital image processing apparatus. For the preview image, exposure information in real-time for each frame is shown in a histogram. When an image stored in a digital image processing apparatus is reproduced, a histogram of the total area of the reproduced image is calculated and provided or a histogram of a particular interest area can be provided by an operation of a user.

Many times, when a picture of an object, such as a person's face, is taken in a condition where the background is bright, the object appears dark because of the significant difference in exposure between the object and the background. In such a case, the problem is that the exposure of the object, or the face area, cannot be recognized using the conventional histogram calculated by the digital image processing apparatus.

According to a conventional histogram display method, the exposure information of the total image is provided as a picture-in-picture image as shown in FIG. 1. In general, a user expects that an appropriate exposure be provided to the main object for photographing the image. Since the main object is typically a person's face, a step of determining whether an appropriate exposure is provided to the face of a person is needed. However, when a histogram is obtained with the total frame of an image, it is difficult to determine where information regarding the face of a person is located in the histogram.

### SUMMARY OF THE INVENTION

To solve the above and/or other problems, the present invention provides a digital image processing apparatus that can produce or correct an exposure value preferred by a user for a preview image and numerically provide the exposure information of a photographed image for a reproduced image, by displaying a histogram of a face area in a predetermined or arbitrary area of the total image, and an operation method thereof.

The present invention provides a digital image processing apparatus that can produce or correct an exposure value preferred by a user for a preview image and numerically provide the exposure information of a photographed image for a reproduced image, by respectively displaying a histogram of a face area of a person, who is the main object, and a histogram of a total image, and an operation method thereof.

The present invention provides a digital image processing apparatus that can produce or correct an exposure value preferred by a user for a preview image and numerically provide the exposure information of a photographed image for a reproduced image, by indicating a position where a histogram of a face area of a person, who is the main object, is located in a histogram of a total image, and an operation method thereof.

According to an aspect of the present invention, there is provided a digital image processing apparatus for displaying a histogram, the apparatus including a face recognition portion recognizing at least one face area from a total image that is displayed; a histogram generation portion generating a histogram of the recognized face area; and a control portion controlling that the histogram of the face area be displayed in an arbitrary area of the total image.

According to another aspect of the present invention, there is provided a digital image processing apparatus for displaying a histogram, the apparatus including a face recognition portion recognizing at least one face area from a total image that is displayed; a histogram generation portion generating a histogram of the total image and a histogram of the recognized face area; and a control portion controlling that the histogram of the total image and the histogram of the face area be respectively displayed in arbitrary areas of the total image.

According to another aspect of the present invention, there is provided a digital image processing apparatus for displaying a histogram, the apparatus including a face recognition portion recognizing at least one face area from a total image that is displayed; a histogram generation portion generating a histogram of the total image and a histogram of the recognized face area; and a control portion controlling that the histogram of the total image be displayed in an arbitrary area of the total image and a position indicating where the histogram of the face area is located in the histogram of the total area.

According to another aspect of the present invention, there is provided a method for operating a digital image processing apparatus that displays a histogram, the method including recognizing at least one face from a displayed arbitrary image; generating a histogram of the recognized face area; and displaying a histogram of the face area in an arbitrary area of the displayed area.

According to another aspect of the present invention, there is provided a method for operating a digital image processing apparatus that displays a histogram, the method including recognizing at least one face from a displayed image; generating a first histogram of the recognized total image and a second histogram of at least one face area; and respectively displaying the first and second histograms in arbitrary areas of the displayed image.

According to another aspect of the present invention, there is provided a method for operating a digital image processing apparatus that displays a histogram, the method including recognizing at least one face from a displayed image; generating a first histogram of the recognized total image; generating a second histogram of the recognized face area and calculating an average of the second histogram; and displaying the first histogram in an arbitrary area of the displayed image and indicating a position where the average of the second histogram is located in the first histogram.

### BRIEF DESCRIPTION OF THE DRAWINGS

The above and other features and advantages of the present invention will become more apparent by describing in detail preferred embodiments thereof with reference to the attached drawings in which:

FIG. 1 is an image showing an example of a histogram displayed in a conventional digital image processing apparatus;

FIG. 2 is a perspective view showing front and top sides of a digital image processing apparatus, according to an embodiment of the present invention;

FIG. 3 is a rear view of the digital image processing apparatus of FIG. 2;

FIG. 4 is a block diagram showing the configuration of a digital image processing apparatus that displays a histogram according to an embodiment of the present invention;

FIGS. 5A and 5B respectively are block diagrams of histogram generation portions of the digital image processing apparatus of FIG. 4, according to first and second embodiments of the present invention;

FIG. 6 is an image showing histograms generated by the histogram generation portion of FIG. 5A, according to the first embodiment of the present invention;

FIG. 7 is an image showing a histogram generated by the histogram generation portion of FIG. 5B, according to the second embodiment of the present invention;

FIG. 8 is a flow chart of an operation method of a digital image processing apparatus for displaying a histogram according to an embodiment of the present invention;

FIG. 9 is a flow chart of an operation method of a digital image processing apparatus for displaying a histogram according to another embodiment of the present invention;

FIG. 10 is a flow chart of an operation method of a digital image processing apparatus for displaying a histogram according to another embodiment of the present invention;

FIG. 11 is a flow chart of an operation method of a digital image processing apparatus for displaying a histogram according to another embodiment of the present invention;

FIG. 12 is a flow chart of an operation method of a digital image processing apparatus for displaying a histogram according to another embodiment of the present invention; and

FIG. 13 is a flow chart of an operation method of a digital image processing apparatus for displaying a histogram according to another embodiment of the present invention.

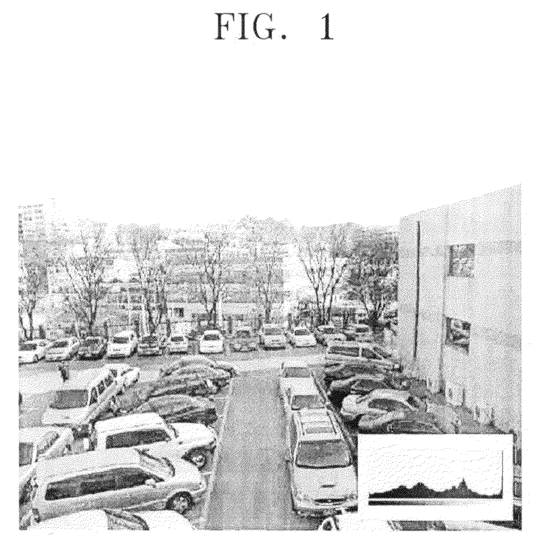

### DETAILED DESCRIPTION OF THE INVENTION

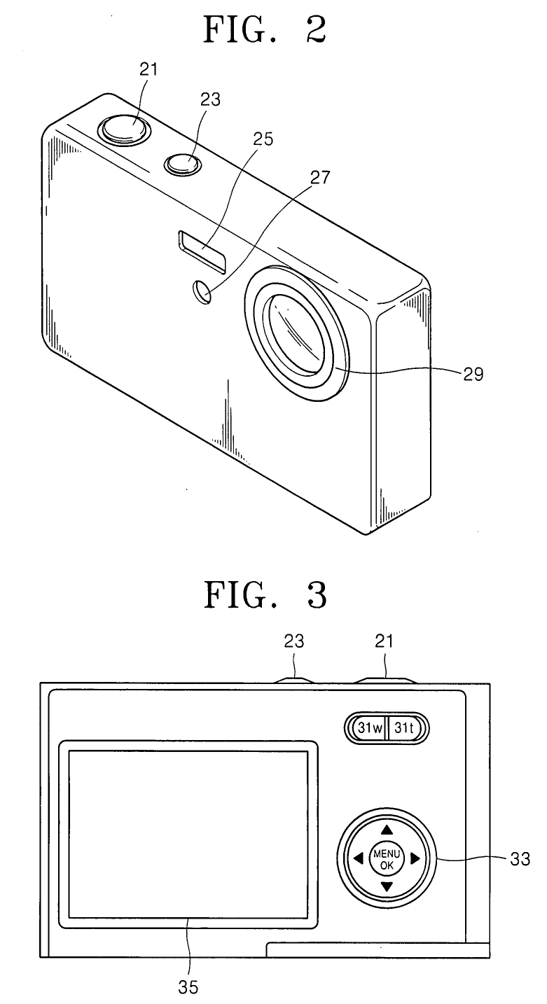

FIG. 2 is a perspective view showing front and top sides of a digital image processing apparatus, according to an embodiment of the present invention. Referring to FIG. 2, the digital image processing apparatus includes a shutter release button 21, a power button 23, a flash 25, an auxiliary light 27, and a lens portion 29. The shutter release button 21 opens and closes in order to expose a CCD or film to light for a predetermined period of time and records pictures in the CCD by appropriate exposure by operating an iris (not shown).

The shutter release button 21 generates a first shooting signal and a second shooting signal in response to a user's input. The first shooting signal corresponds to a half-shutter signal and the second shooting signal corresponds to a full shutter signal. When the first shooting signal is input, the digital image processing apparatus focuses and adjusts the quality of light. When the digital image processing apparatus is focused, green light appears on a display panel 35. Thereafter, shooting is performed when the second shooting signal is input.

The power button 23 turns on and off power to the digital image processing apparatus. The flash 25 emits light when photographing in a dark place. A flash mode includes automatic flash, forced light emission, light emission prevention, red eye reduction, and slow sync. The auxiliary light 27 supplies light to an object so that the digital image processing apparatus can focus automatically, quickly, and accurately when photographing with an insufficient amount of light or at night. The lens portion 29 receives light from an external light source and processes an image.

FIG. 3 is a rear view of the digital image processing apparatus of FIG. 2. Referring to FIG. 3, a wide-angle zoom button 31w, a telephoto zoom button 31t, a function button 33, and the display portion 35 are provided on the rear side of the digital image processing apparatus.

The wide-angle zoom button 31w and the telephoto zoom button 31t are used to change a viewing angle according to an input by a user, in particular, to change the size of a selected exposure area. If the wide-angle zoom button 31w is pressed, the size of a selected exposure area is decreased. If the telephoto zoom button 31t is pressed, the size of a selected exposure area is increased.

The function button 33 includes five buttons including an up button, a down button, a left button, a right button, and a menu/OK button. The function button 33 is used to access various menus related to the operation of the digital image processing apparatus, and each function button 33 can be used as a shortcut key.

FIG. 4 is a block diagram showing the configuration of the digital image processing apparatus that displays a histogram according to an embodiment of the present invention. Referring to FIG. 4, the digital image processing apparatus according to the present invention includes the display portion 35, a user input portion 41, a photographing portion 43, an image processing portion 45, a storing portion 47, a face recognition portion 49, a histogram generation portion 51, and a control portion 53.

The user input portion 41, referring to FIGS. 2 and 3, includes the shutter release button 21 that opens and closes the shutter to expose a CCD or film to light for a predetermined time, the power button 23 to turn on/off the operation of the digital image processing apparatus, the wide-angle zoom button 31w or the telephoto zoom button 31t increasing or decreasing a viewing angle according to an input by a user, and the function button 33 used to access various menus related to the operation of the digital image processing apparatus.

The photographing portion 43 includes the shutter release button 21, the lens portion 29, the aperture, the CCD, and an ADC (analog-to-digital converter). The shutter release button 21 is a mechanism that adjusts the amount of light for exposure with the aperture. The lens portion 29 receives light from an external light source and processes an image, and includes a zoom lens, a focus lens, and a compensation lens. The aperture adjusts the amount of light input according to a degree of its opening that is controlled by the control portion 53.

During the AF (auto focus), a focus motor (not shown) moving the focus lens is driven by the control portion 53, and accordingly, the focus lens is moved from the front to the back of the lens from the foremost to the rearmost. During the movement, the position of the focus lens where a high frequency component of an image signal increases most, for example, the number of drive steps of the focus motor, is set.

The CCD accumulates the amount of light input through the lens portion 29 and outputs an image photographed by the lens portion 29 according to the accumulated amount of light corresponding to a vertical sync signal. In the digital image processing apparatus, an image is obtained by the CCD that converts the light reflected from the object into an electric signal. To obtain a color image using the CCD, a color filter is needed and a filter (not shown), which is referred to as a color filter array (CFA), is typically used. The CFA transmits only light indicating a single color for each pixel and has a regularly arranged structure. The CFA has various shapes according to its arrangement structure. The ADC converts an analog image signal output from the CCD into a digital signal.

The image processing portion 45 performs signal processing so that the digitally converted image signal can be displayed. A device used for the CCD and CFA filter is sensitive to a change in temperature so that a dark current is generated according to the change in temperature and a black level that is not desirable is included in the image signal. Thus, the image processing portion 45 removes the black level generated by the dark current, and performs gamma correction. Since the vision of humans reacts non-linearly to the brightness according to Weber's law, if a limited bit depth is given and the brightness of light is linearly recorded, posterization is generated. Thus, in order to provide the highest picture quality at a given bit depth, it is necessary to perform coding using a non-linear function. The encoding of information corresponding to the non-linearity of the vision of humans is referred to as gamma correction. The image processing portion 45 gamma corrects an image signal input by a gamma curve and outputs a gamma corrected image signal, for example, the input brightness level of a 12-bit image signal is corrected to an 8-bit brightness level.

The image processing portion 45 performs a CFA interpolation that interpolates a bayer pattern embodied by an RGRG line and a GBGB line of a predetermined data that is gamma corrected to an RGB line. In the CFA interpolation of the image processing portion 45, a G channel is first restored from pixels where only an R or B channel value exists and then empty values are filled in order of B and R channels or R and B channels so that the three R, G, and B channels are restored.

The image processing portion 45 converts an interpolated RGB signal to a YUV signal, performs an edge compensation and a color correction, and removes noise from signals. In the edge compensation, a Y signal is filtered by a high pass filter in order to clear an image. In the color correction, the color value of U and V signals are corrected using a standard color coordinate system.

The image processing portion 45 generates an Exif filed by compressing and signal processing the Y, U, and V signals from which noise is removed, and the generated Exif file is displayed on the display portion 35 and stored in the storing portion 47.

The face recognition portion 49 detects information regarding the face of a person, which is typically the main object. This may include information regarding the number of faces and information regarding the position of each face in the display portion 35, from the preview image displayed on the display portion 35 using the generated Exif file. Also, the face recognition portion 49 reproduces the image stored in the storing portion 47 on the display portion 35 and detects information regarding the face of a person, which is typically the main object. This includes information regarding the number of faces and information regarding the position of each face in the display portion 35, from the reproduced image. The face information of the reproduced image can be stored in a MakerNote data area of the Exif file, which typically exists in an Exif file as a user definition area that can be used for a purpose according to each manufacturer. In the present embodiment, the face information generated by the face recognition portion 49 is stored in the MakerNote data area of the Exif file. In the alternative, face-related information can be stored in areas other than the MakerNote data area of the Exif file that are in or associated with the image file. Face-related information can also be stored in data structures other than those defined by the Exif file format.

The histogram generation portion 51 generates a histogram corresponding to the total image displayed on the display portion 35 and/or a histogram corresponding to a part of the image such as to one or more face areas using information regarding the position and number of faces generated by the face recognition portion 49. In the present embodiment, the histogram generation portion 51 generates a histogram indicating the number of pixels according to the brightness value of the Y signal generated by the image processing portion 45. When the histogram is generated, the horizontal axis indicates the brightness value of the Y signal, for example, a value between 0 to 255. The vertical axis indicates the frequency generated with respect to each pixel value.

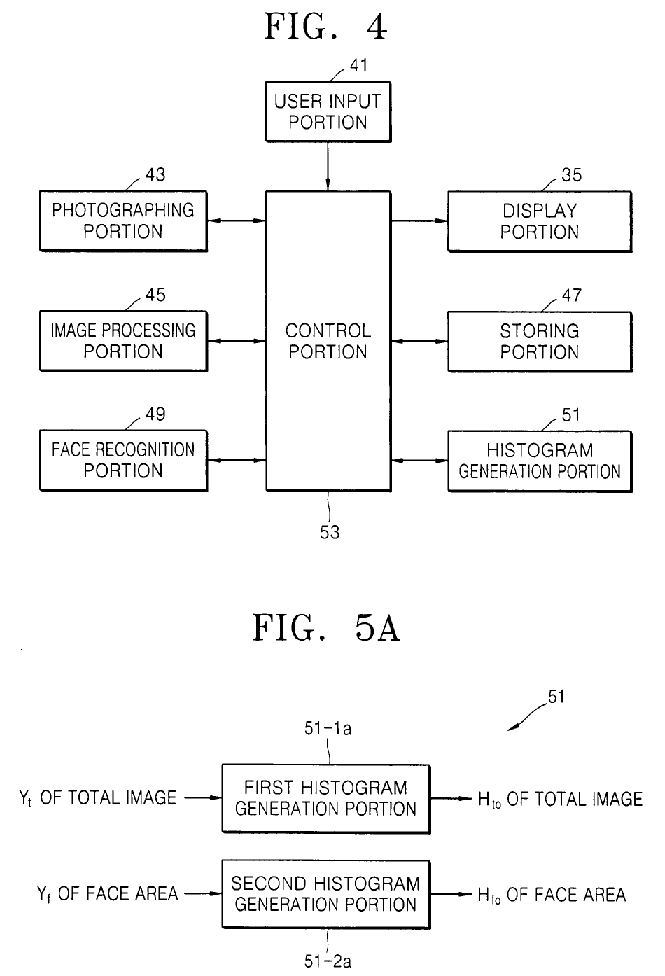

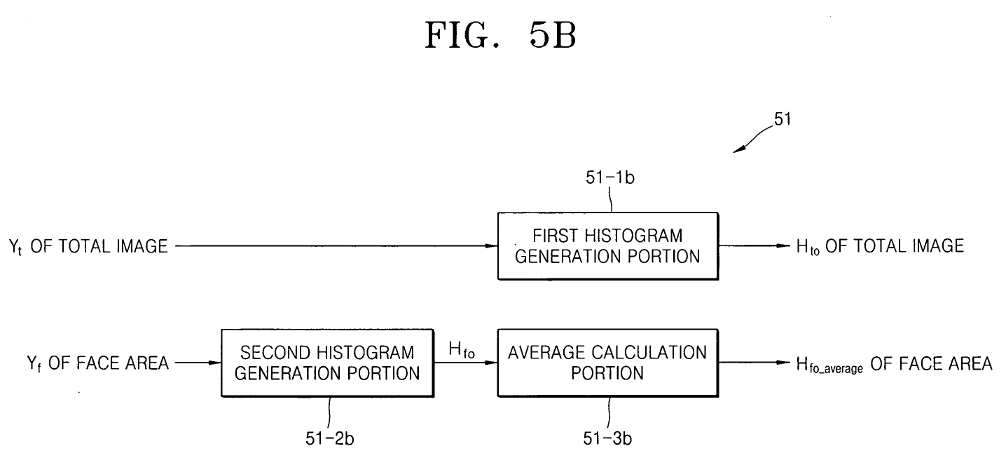

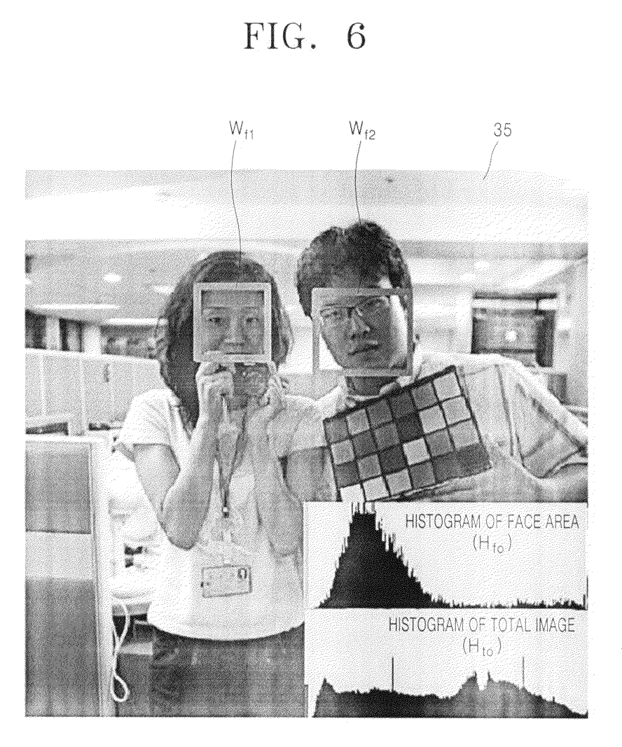

FIGS. 5A and 5B respectively are block diagrams of the histogram generation portion 51 of the digital image processing apparatus, according to first and second embodiments of the present invention. Referring to the first embodiment shown in FIG. 5A, a first histogram generation portion 51-1a generates a histogram Hₜₒ indicating the frequency according to the brightness value of a signal Yₜ of a preview image or a histogram Hₜₒ indicating the frequency according to the brightness value of a signal Yₜ of the total image stored in the storing portion 47 and reproduced on the display portion 35. The second histogram generation portion 51-2a receives the face information of a preview image or reproduced image (the number of faces and the position coordinate of each face) and generates a histogram H_{fo} indicating the frequency according to the brightness value of the signal Y_{f} of a face area.

Referring back to FIG. 4, the control portion 53 receives the histogram Hₜₒ of the total image and the histogram H_{fo} of the face area from the histogram generation portion 51 and displays the histogram Hₜₒ of the total image and the histogram H_{fo} of the face area in a predetermined or arbitrary area of the display portion 35.

FIG. 6 is an image showing histograms generated by the histogram generation portion 51 of FIG. 5A, according to the first embodiment of the present invention. Referring to FIG. 6, the histogram Hₜₒ of the total image and the histogram H_{fo} of face areas (W_{f1} and W_{f2}) are respectively displayed in arbitrary areas of the display portion 35 that displays the image. Through the histogram Hₜₒ of the total image and the W_{f1} and W_{f2} that are displayed in the arbitrary areas of the display portion 35, for a preview image, an exposure value preferred by a user can be obtained or corrected for photographing and, for a reproduced image, the exposure of the photograph can be numerically provided.

According to the second embodiment shown in FIG. 5B, a first histogram generation portion 51-1b generates a histogram Hₜₒ indicating the frequency according to a brightness value of a signal Yₜ of a preview image or a histogram Hₜₒ indicating the frequency according to a brightness value of a signal Yₜ of the total image that is stored in the storing portion 47 and reproduced on the display portion 35. A second histogram generation portion 51-2b receives the face information (the number of faces and position coordinates of a face) regarding the preview image or reproduced image from the face recognition portion 49 and generates a histogram H_{fo} indicating the frequency according to the brightness value of the signal Y_{f} of the face area. An average calculation portion 51-3b calculates and outputs a histogram average H_{fo}_{_{—}}_{average} of the face areas (W_{f1} and W_{f2}) from the second histogram generation portion 51-2b.

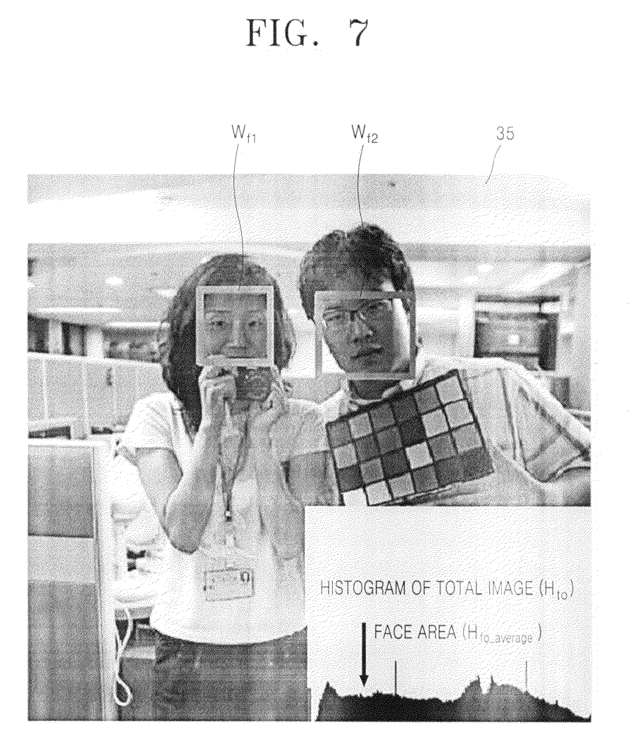

Referring back to FIG. 4, the control portion 53 as shown in FIG. 5B receives the histogram Hₜₒ of the total image and the W_{f1} and W_{f2} from the histogram generation portion 51 and displays the histogram Hₜₒ of the total image in an arbitrary area of the display portion 35 with the W_{f1} and W_{f2} indicated in a certain area of the histogram Hₜₒ of the total image as shown in FIG. 7.

FIG. 7 is an image showing a histogram generated by the histogram generation portion 51 of FIG. 5B, according to the second embodiment of the present invention. FIG. 7 shows an example of an indication of where the W_{f1} and W_{f2} is located in the histogram Hₜₒ of the total image. Specifically, the embodiment shown in FIG. 7 indicates the histogram average H_{fo}_{_{—}}_{average} of the face areas (W_{f1} and W_{f2}). In an alternate embodiment (not shown), the histogram average for one or more individual face areas may be indicated. For example, H_{f1}_{_{—}}_{average} and/or H_{f2}_{_{—}}_{average} may be shown. For the preview image, an exposure value preferred by a user can be obtained or corrected for photographing. For the reproduced image, the exposure of a photograph can be quantitatively provided.

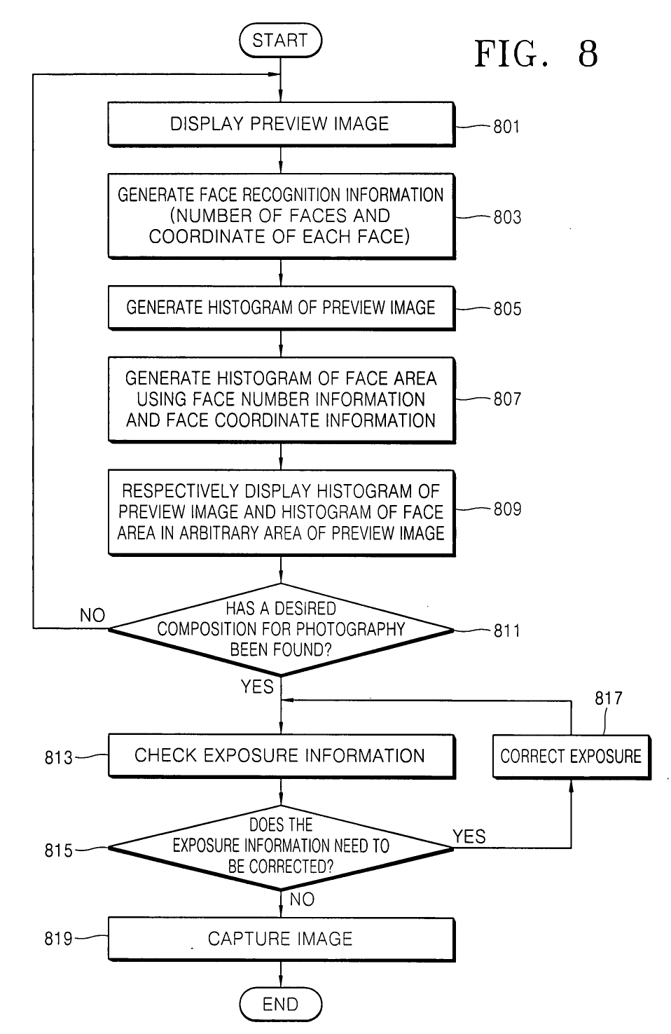

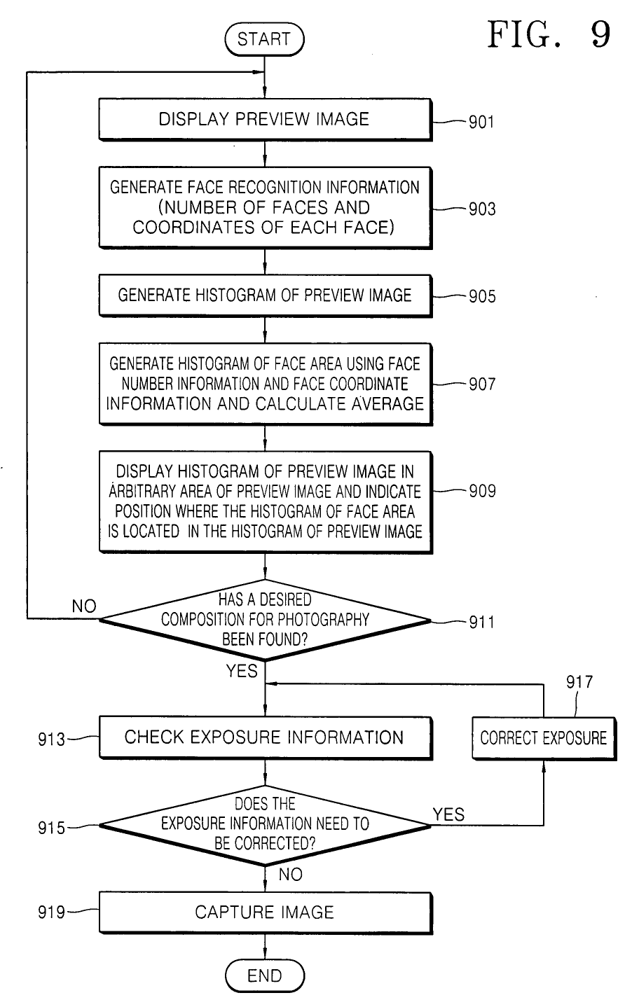

FIGS. 8 to 13 are flow charts of the operation method of a digital image processing apparatus that displays a histogram according to six additional embodiments of the present invention. The operation method of the digital image processing apparatus that displays a histogram according to the present invention can be performed inside the digital image processing apparatus as shown in FIG. 4. The main algorithm of the operation method can be performed inside the control portion 53 with the help of the other constituent elements in the digital image processing apparatus according to the embodiments of the present invention.

The operation method of the digital image processing apparatus that displays a histogram according to a first embodiment of the present invention shown in FIG. 8 will be described as follows.

When a user sets a composition for photographing, the control portion 53 displays a preview image on the display portion 35 (S801). When the preview image is displayed on the display portion 35, the control portion 53 controls the face recognition portion 49 to generate face recognition information regarding the displayed preview image (S803). The face recognition portion 49 generates information regarding the number of faces displayed on the preview image and information regarding the position of each face, under the control of the control portion 53.

The control portion 53 controls the histogram generation portion 51 to generate a histogram of the total preview image (S805). The histogram generation portion 51 generates a histogram Hₜₒ indicating the frequency according to the brightness value of the signal Yₜ of the preview image.

The control portion 53 receives the information regarding the number of faces and information regarding the position of each face from the face recognition portion 49 and controls the histogram generation portion 51 to generate a histogram of a face area using the received information (S807). The histogram generation portion 51 generates a histogram H_{fo} indicating the frequency according to the brightness value of the signal Y_{f} of the face area image.

The control portion 53 displays the histogram Hₜₒ of the preview image and the histogram H_{fo} of the face area image in an arbitrary area of the display portion 35 that displays the preview image (S809). FIG. 6 shows an example in which the histogram Hₜₒ of the total image and the histogram H_{fo} of the face areas (W_{f1} and W_{f2}) are respectively displayed in arbitrary areas of the display portion 35 that displays the image.

A user can find a desired composition for photographing by seeing the histogram Hₜₒ of the preview image and the histogram H_{fo} of the face area image. The control portion 53 determines whether the user finds a desired composition for photographing (S811).

If the user finds a desired composition for photographing, the exposure information of the present preview state is checked (S813). However, if the user fails to find a desired composition for photographing, the user moves the composition for photographing and, whenever the user moves the composition for photographing, operations S801 to S809 are repeated. In the present embodiment, the preview image displayed on the display 35 can be changed by 30 frames per second, and the control portion 53 controls the face recognition portion 49 and the histogram generation portion 51 to generate the face recognition information and the histograms Hₜₒ and H_{fo} in real-time according to each frame. In other embodiments, the preview image and corresponding histograms can change by greater than or less than 30 frames per second.

The exposure information of the present preview state is checked and the user determines whether to correct the exposure (S815). In the present embodiment, if the user wishes to correct the exposure, an exposure correction signal is automatically or manually generated using the function button 33. The control portion 53 receives the generated exposure correction signal and performs the exposure correction (S817).

If the exposure correction is not needed for the preview image in a desired composition for photographing or the exposure correction is complete, the control portion 53 receives an input signal of the shutter release button 21 by the user and captures an image (S819).

FIG. 9 is a flow chart of the operation method of a digital image processing apparatus for displaying a histogram, according to a second embodiment of the present invention. Referring to FIG. 9, when a user sets a composition for photographing, the control portion 53 displays a preview image on the display portion 35 (S901). When the preview image is displayed on the display portion 35, the control portion 53 controls the face recognition portion 49 to generate face recognition information regarding the displayed preview image (S903). The face recognition portion 49 generates information regarding the number of faces displayed on the preview image and information regarding the position of each face, under the control of the control portion 53.

The control portion 53 controls the histogram generation portion 51 to generate a histogram of the total preview image (S905). The histogram generation portion 51 generates a histogram Hₜₒ indicating the frequency according to the brightness value of the signal Yₜ of the preview image.

The control portion 53 receives the information regarding the number of faces and information regarding the position of each face from the face recognition portion 49 and controls the histogram generation portion 51 to generate a histogram of a face area using the received information and calculate an average thereof (S907). The histogram generation portion 51 generates a histogram H_{fo} indicating the frequency according to the brightness value of the signal Y_{f} of the face area image as shown in FIG. 5B and calculates the histogram average H_{fo}_{_{—}}_{average} of the face area.

The control portion 53 receives the histogram Hₜₒ of the preview image and the histogram average H_{fo}_{_{—}}_{average} of the face area from the histogram generation portion 51 and displays the histogram Hₜₒ of the preview image in an arbitrary area of the display portion 35 that displays the preview image and indicates where the histogram average H_{fo}_{_{—}}_{average} of the face area is located in the histogram Hₜₒ of the preview image (S909). FIG. 7 shows an example of an indication of where the histogram average H_{fo}_{_{—}}_{average} of the face areas (W_{f1} and W_{f2}) is located in the histogram Hₜₒ of the preview image.

A user can find a desired composition for photographing by reviewing the location of the histogram H_{fo}_{_{—}}_{average} of the face areas (W_{f1} and W_{f2}) in the histogram Hₜₒ of the preview image. As such, the control portion 53 determines whether the user finds a desired composition for photographing (S911).

If the user finds a desired composition for photographing, the exposure information of the present preview state is checked (S913). However, when the user fails to find a desired composition for photographing, the user moves the composition for photographing and, whenever the user moves the composition for photographing, operations S901 to S909 are repeated. The preview image displayed on the display 35 can be changed by 30 frames per second, and the control portion 53 controls the face recognition portion 49 and the histogram generation portion 51 to generate the face recognition information, the histogram Hₜₒ of the preview image, and the histogram average H_{fo}_{_{—}}_{average} of the face areas (W_{f1} and W_{f2}) in real-time according to each frame.

The exposure information of the present preview state is checked and the user determines whether to correct the exposure (S915). If the user wishes to correct the exposure, an exposure correction signal is automatically or manually generated using the function button 33. The control portion 53 receives the generated exposure correction signal and performs the exposure correction (S917).

If the exposure correction is not needed for the preview image in a desired composition for photographing or the exposure correction is complete, the control portion 53 receives an input signal of the shutter release button 21 by the user and captures an image (S919).

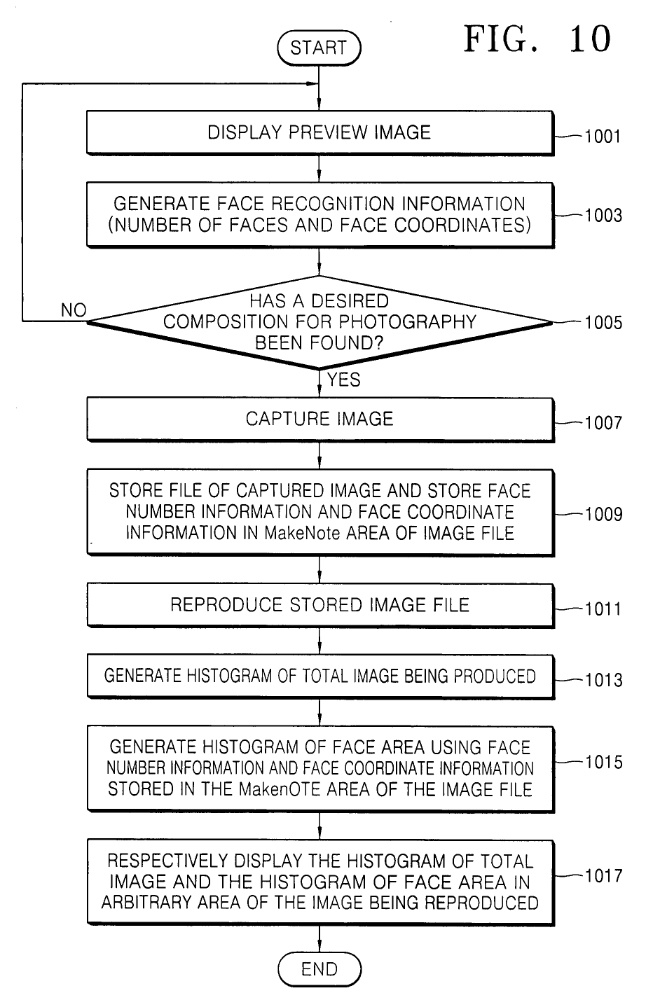

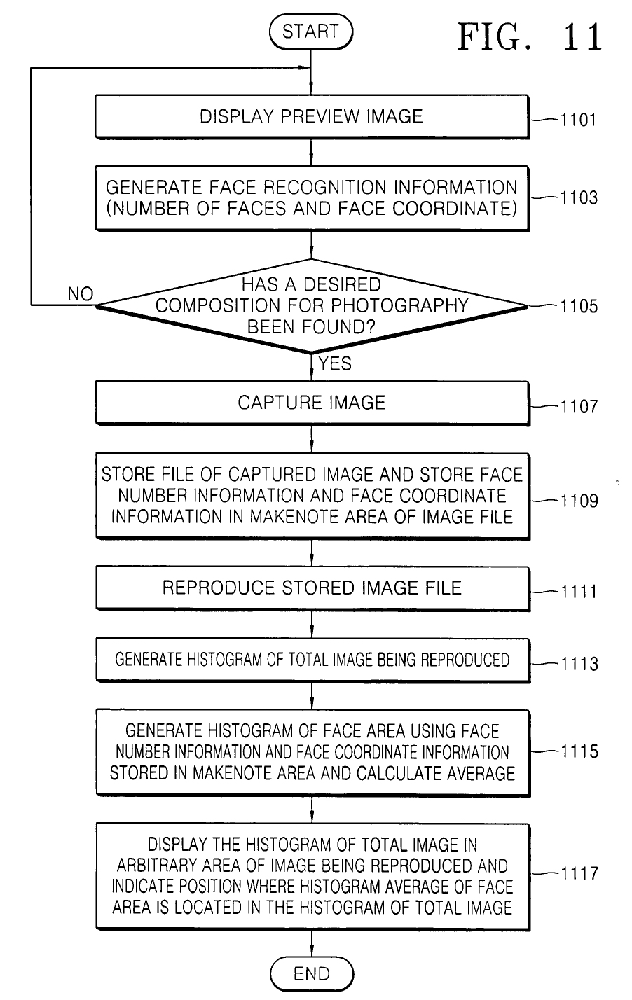

FIG. 10 is a flow chart of the operation method of a digital image processing apparatus for displaying a histogram according to the third embodiment of the present invention. Referring to FIG. 10, when a user sets a composition for photographing, the control portion 53 displays a preview image on the display portion 35 (S1001). When the preview image is displayed on the display portion 35, the control portion 53 controls the face recognition portion 49 to generate face recognition information regarding the displayed preview image (S1003). The face recognition portion 49 generates information regarding the number of faces displayed on the preview image and information regarding the position of each face, under the control of the control portion 53. In other embodiments, face recognition information may be generated at later times, for example, after the respective image has been captured.

A user can find a desired composition for photographing by seeing the preview image. The control portion 53 determines whether the user finds a desired composition for photographing (S1005). If the user fails to find a desired composition for photographing, the user moves the composition for photographing and, whenever the user moves the composition for photographing, operations S1001 and S1003 are repeated. The preview image displayed on the display 35 can be changed by 30 frames per second, and the control portion 53 controls the face recognition portion 49 to generate the face recognition information in real-time according to each frame.

When the user finds a desired composition for photographing, the user presses the shutter release button 21 and thus the control portion 53 captures an image (S1007). When the image is captured, an image file (Exif file) is generated and stored in the storing portion 47. Other types of image files may be generated in other embodiments. The control portion 53 stores the face number information and the face position information generated by the face recognition portion 49 in a MakerNote data area of the image file (S1009). The MakerNote data area is provided in the image file as a user definition area that can be used for a purpose according to each manufacturer. The face information generated by the face recognition portion 49 is stored in the MakerNote data area under the control of the control portion 53.

When the user selects reproduction, the control portion 53 selects the image file stored in the storing portion 47 and reproduces the selected image file in the display portion 35 (S1011). When the image file is reproduced in the display portion 35, the control portion 53 controls the histogram generation portion 51 to generate a histogram of the total image that is being reproduced (S1013). The histogram generation portion 51 generates a histogram Hₜₒ indicating the frequencies according to the brightness value of the signal Yₜ of the reproduced image under the control of the control portion 53.

The control portion 53 controls the histogram generation portion 51 to generate a histogram of a face area using the face number information and the face position information stored in the MakerNote data area of the image file (S1015). The histogram generation portion 51 generates a histogram H_{fo} indicating the frequencies according to the brightness value of the signal Y_{f} of the face area image under the control of the control portion 53.

The control portion 53 displays the histogram Hₜₒ of the total image being reproduced and the histogram H_{fo} of the face area in an arbitrary area of the display portion 35 that displays the image (S1017). FIG. 6 shows an example in which the histogram Hₜₒ of the total image being reproduced and the histogram H_{fo} of the face areas (W_{f1} and W_{f2}) are respectively displayed in arbitrary areas of the display portion 35 that displays the image.

FIG. 11 is a flow chart of the operation method of a digital image processing apparatus for displaying a histogram according to the fourth embodiment of the present invention. Referring to FIG. 11, when a user sets a composition for photographing, the control portion 53 displays a preview image on the display portion 35 (S1101). When the preview image is displayed on the display portion 35, the control portion 53 controls the face recognition portion 49 to generate face recognition information regarding the displayed preview image (S1103). The face recognition portion 49 generates information regarding the number of faces displayed on the preview image and information regarding the position of each face, under the control of the control portion 53.

A user can find a desired composition for photographing by seeing the preview image. The control portion 53 determines whether the user finds a desired composition for photographing (S1105). If the user fails to find a desired composition for photographing, the user moves the composition for photographing and, whenever the user moves the composition for photographing, operations S1101 and S1103 are repeated. The preview image displayed on the display 35 can be changed by 30 frames per second. The control portion 53 controls the face recognition portion 49 to generate the face recognition information in real-time according to each frame.

If the user finds a desired composition for photographing, the user presses the shutter release button 21 and thus the control portion 53 captures an image (S1107). When the image is captured, an image file (Exif file) is generated and stored in the storing portion 47. The control portion 53 stores the face number information and the face position information generated by the face recognition portion 49 in a MakerNote data area of the image file (S1109). The MakerNote data area is provided in the image file as a user definition area that can be used for a purpose according to each manufacturer. The face information generated by the face recognition portion 49 is stored in the MakerNote data area under the control of the control portion 53.

When the user selects reproduction, the control portion 53 selects the image file stored in the storing portion 47 and reproduces the selected image file in the display portion 35 (S1111). When the image file is reproduced in the display portion 35, the control portion 53 controls the histogram generation portion 51 to generate a histogram of the total image that is being reproduced (S1113). The histogram generation portion 51 generates a histogram Hₜₒ indicating the frequencies according to the brightness value of the signal Yₜ of the reproduced image under the control of the control portion 53.

The control portion 53 controls the histogram generation portion 51 to generate a histogram of a face area using the face number information and the face position information stored in the MakerNote data area of the image file (S1115). The histogram generation portion 51 generates a histogram H_{fo} indicating the frequencies according to the brightness value of the signal Y_{f} of the face area image under the control of the control portion 53. The histogram generation portion 51 generates the histogram H_{fo} of the signal Y_{f} of the face area image and the histogram average H_{fo}_{_{—}}_{average} as shown in FIG. 5B.

The control portion 53 receives the histogram Hₜₒ of the reproduced image and the histogram average H_{fo}_{_{—}}_{average} of the face area image from the histogram generation portion 51 and displays the histogram Hₜₒ of the total image being reproduced in an arbitrary area of the display portion 35 that displays the image and indicates where the histogram average H_{fo}_{_{—}}_{average} of the face area image is located in the histogram Hₜₒ of the reproduced image (S1117). FIG. 7 shows an example of an indication of where the histogram average H_{fo}_{_{—}}_{average} of the face areas (W_{f1} and W_{f2}) is located in the histogram Hₜₒ of the total image.

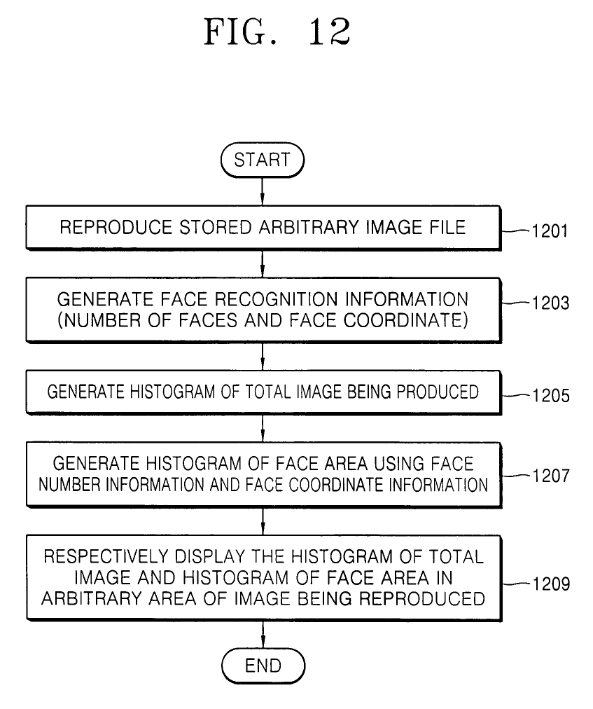

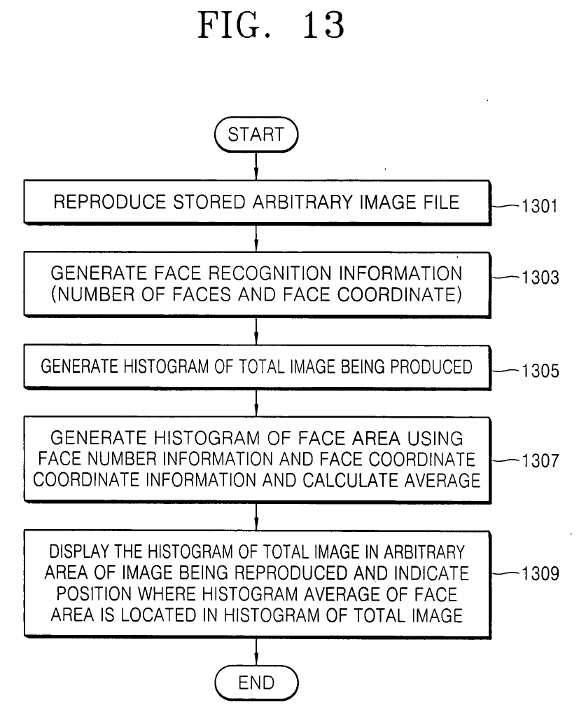

FIG. 12 is a flow chart of the operation method of a digital image processing apparatus for displaying a histogram, according to the fifth embodiment of the present invention. Referring to FIG. 12, when a user selects reproduction, the control portion 53 selects an image file stored in the storing portion 47 and reproduces the selected image file in the display portion 35 (S1201). When the image file is reproduced in the display portion 35, the control portion 53 controls the face recognition portion 49 to generate face recognition information regarding the reproduced image (S1203). The face recognition portion 49 generates information regarding the number of faces displayed on the reproduced image and information regarding the position of each face under the control of the control portion 53.

The control portion 53 controls the histogram generation portion 51 to generate a histogram of the total image being reproduced (S1205). The histogram generation portion 51 generates a histogram Hₜₒ indicating the frequencies according to the brightness value of the signal Yₜ of the reproduced image under the control of the control portion 53.

The control portion 53 receives the face number information and the face position information from the face recognition portion 49 and controls the histogram generation portion 51 to generate a histogram of the face area using the received information (S1207). The histogram generation portion 51 generates a histogram H_{fo} indicating the frequencies according to the brightness value of the signal Y_{f} of the face area image under the control of the control portion 53.

The control portion 53 displays the histogram Hₜₒ of the total image and the histogram H_{fo} of the face area image in an arbitrary area of the display portion 35 that displays the total image (S1209). FIG. 6 shows an example in which the histogram Hₜₒ of the total image and the histogram H_{fo} of the face areas (W_{f1} and W_{f2}) are respectively displayed in arbitrary areas of the display portion 35 that displays the image.

FIG. 13 is a flow chart of the operation method of a digital image processing apparatus for displaying a histogram, according to the sixth embodiment of the present invention. Referring to FIG. 13, when a user selects reproduction, the control portion 53 selects an image file stored in the storing portion 47 and reproduces the selected image file in the display portion 35 (S1301). When the image file is reproduced in the display portion 35, the control portion 53 controls the face recognition portion 49 to generate face recognition information regarding the reproduced image (S1303). The face recognition portion 49 generates information regarding the number of faces displayed on the reproduced image and information regarding the position of each face under the control of the control portion 53.

The control portion 53 controls the histogram generation portion 51 to generate a histogram of the total image being reproduced (S1305). The histogram generation portion 51 generates a histogram Hₜₒ indicating the frequencies according to the brightness value of the signal Yₜ of the reproduced image under the control of the control portion 53.

The control portion 53 receives the face number information and the face position information from the face recognition portion 49 and controls the histogram generation portion 51 to generate a histogram of the face area using the received information and calculate an average thereof (S1307). The histogram generation portion 51 generates a histogram H_{fo} indicating the frequencies according to the brightness value of the signal Y_{f} of the face area image under the control of the control portion 53. The histogram generation portion 51 as shown in FIG. 5B generates the histogram H_{fo} of the signal Y_{f} of the face area image and calculates the histogram average H_{fo}_{_{—}}_{average} of the face area.

The control portion 53 receiving the histogram Hₜₒ of the total image being reproduced and the histogram average H_{fo}_{_{—}}_{average} of the face area from the histogram generation portion 51 displays the histogram Hₜₒ of the total image in an arbitrary area of the display portion 35 that displays the total image and indicates where the histogram average H_{fo}_{_{—}}_{average} of the face area is located in the histogram Hₜₒ of the total image (S1309). FIG. 7 shows an example of an indication of where the histogram H_{fo}_{_{—}}_{average} of the face areas (W_{f1} and W_{f2}) is located in the histogram Hₜₒ of the total image that has been reproduced.

As described above, according to the present invention, a histogram of a face area of a person, who is the main object, is displayed in an arbitrary area of a total image. For a preview image, an exposure value preferred by a user can be obtained or corrected. For a reproduced image, the exposure of a photograph can be quantitatively seen.

The histogram of a total image and the histogram of a face area of a person, who is the main object, are respectively displayed. Thus, for a preview image, an exposure value preferred by a user can be obtained or corrected and, for a reproduced image, the exposure of a photograph can be quantitatively seen.

Also, by indicating where the histogram of a face area of a person, who is the main object, is located in the histogram of the total image, for a preview image, an exposure value preferred by a user can be obtained or corrected and, for a reproduced image, the exposure of a photograph can be quantitatively seen.

While this invention has been particularly shown and described with reference to preferred embodiments thereof, it will be understood by one skilled in the art that various changes in form and details may be made therein without departing from the spirit and scope of the invention as defined by the appended claims.

What is claimed is:

1. A digital image processing apparatus comprising:
a face recognition portion recognizing at least one face area in an image;
a histogram generation portion generating a histogram of the face area; and
a display on which the histogram of the face area is displayed.

2. The digital image processing apparatus of claim 1 further comprising:
a control portion allowing exposure correction of at least a portion of the image.

3. The digital image processing apparatus of claim 1 wherein data corresponding to the histogram of the face area is stored in a user-defined area of an image file corresponding to the image.

4. The digital image processing apparatus of claim 1 wherein the histogram generation portion generates a histogram of the total image, which is displayed at the same time as the histogram of the face area.

5. A digital image processing apparatus comprising:
a photographing element for receiving light and for converting the light to image data corresponding to an image;
a recording medium for storing the image data in an image file; and
a CPU recognizing at least one face area in the image and generating a histogram of the face area and a histogram of the total image.

6. The digital image processing apparatus of claim 5 further comprising:
a display displaying the histogram of the total image and an indication of the average of the histogram of the face area.

7. The digital image processing apparatus of claim 5, wherein the CPU corrects the exposure of at least a portion of the image.

8. The digital image processing apparatus of claim 5, wherein data corresponding to the histogram of the face area is stored in a customizable area of the image file.

9. The digital image processing apparatus of claim 5, wherein the CPU comprises:
a first histogram generation portion generating the histogram of the total image;
a second histogram generation portion generating the histogram of the face area; and
an average generation portion generating the average of the histogram of the face area.

10. A method for operating a digital image processing apparatus, the method comprising:
recognizing at least one face area in an image;
generating a histogram of the face area; and
displaying the histogram of the face area.

11. The method of claim 10 further comprising:
storing data corresponding to the histogram of the face area in a user-defined area of an image file corresponding to the image.

12. The method of claim 10 further comprising:
correcting the exposure of at least a portion of the image.

13. The method of claim 10 further comprising:
displaying the image; and
displaying the histogram of the face area over a portion of the image.

14. The method of claim 10 further comprising:
generating a histogram of the total image; and
displaying the histogram of the total image at the same time as the histogram of the face area.

15. A method for operating a digital image processing apparatus, the method comprising:
selecting a partial area of an image;
generating a first histogram of the total image; and
generating a second histogram of the partial area of the image.

16. The method of claim 15 further comprising:
calculating the average of the second histogram;
displaying the first histogram; and
displaying an indication of where the average of the second histogram is located in the first histogram.

17. The method of claim 15 further comprising:
storing data corresponding to the second histogram in a user-defined area of an image file corresponding to the image.

18. The method of claim 16 further comprising:
correcting the exposure of at least a portion of the image.

19. The method of claim 18 further comprising:
updating the first histogram to reflect the exposure correction.

20. The method of claim 18 further comprising:
updating the displayed indication of the average of the second histogram to reflect the exposure correction.
